(19) United States
(12) Patent Application Publication
(10) Pub. No.: US 2026/0031953 A1
(43) Pub. Date: Jan. 29, 2026

(54) SRS CONFIGURATION METHOD AND APPARATUS, AND RELATED DEVICE

(71) Applicant: VIVO MOBILE COMMUNICATION CO., LTD., Guangdong (CN)

(72) Inventors: Xiang PAN, Guangdong (CN); Tingting ZHONG, Guangdong (CN); Wei BAO, Guangdong (CN); Hongping ZHANG, Guangdong (CN)

(73) Assignee: VIVO MOBILE COMMUNICATION CO., LTD., Guangdong (CN)

(21) Appl. No.: 19/348,729

(22) Filed: Oct. 2, 2025

Related U.S. Application Data
(63) Continuation of application No. PCT/CN2024/085145, filed on Apr. 1, 2024.

(30) Foreign Application Priority Data
Apr. 7, 2023 (CN) 202310367256.5

(51) Int. Cl. H04L 5/00; H04W 64/00; H04W 76/27

(52) U.S. Cl. CPC H04L 5/0051; H04W 64/00; H04W 76/27

(57) ABSTRACT

An SRS configuration method and apparatus, and a related device. The SRS configuration method in embodiments of this application includes: A first access network device receives a first SRS configuration sent by a location management function LMF. The first SRS configuration includes validity area information. The validity area information is used for indicating coverage of a second access network device that reserves an SRS resource for a terminal when the terminal is released to a radio resource control RRC inactive state.

### CROSS-REFERENCE TO RELATED APPLICATIONS

This application is a continuation of International Application No. PCT/CN2024/085145 filed on Apr. 1, 2024, which claims priority to Chinese Patent Application No. 202310367256.5 filed on Apr. 7, 2023, which are incorporated herein by reference in their entireties.

### TECHNICAL FIELD

This application relates to the field of communication technologies, and specifically, to an SRS configuration method and apparatus, and a related device.

### BACKGROUND

Currently, after receiving an uplink positioning reference signal configuration request and generating an uplink positioning reference signal configuration, a serving base station may release a terminal to a radio resource control (RRC) inactive (INACTIVE) state. The uplink positioning reference signal configuration used for the RRC_INACTIVE state is sent to the terminal by using an RRC release message. After receiving the configuration, the terminal enters the RRC_INACTIVE state, and sends an uplink positioning reference signal based on the configuration. The uplink positioning reference signal configuration is valid only in a cell that receives the reference signal configuration. When the terminal reselects another cell (a cell that does not receive the reference signal configuration), the configuration is released, and a reconfiguration is needed. Consequently, power consumption of the terminal in the inactive state is high.

### SUMMARY

Embodiments of this application provide an SRS configuration method and apparatus, and a related device.

According to a first aspect, an SRS configuration method is provided, and is performed by a first access network device. The method includes:

The first access network device receives a first SRS configuration sent by a location management function LMF.

The first SRS configuration includes validity area information, and the validity area information is used for indicating coverage of a second access network device that reserves an SRS resource for a terminal when the terminal is released to a radio resource control RRC inactive state.

According to a second aspect, an SRS configuration method is provided, and is performed by an LMF. The method includes:

The LMF sends a first SRS configuration to a first access network device.

The first SRS configuration includes validity area information, and the validity area information is used for indicating coverage of a second access network device that reserves an SRS resource for a terminal when the terminal is released to an RRC inactive state.

According to a third aspect, an SRS configuration method is provided, and is performed by a terminal. The method includes:

The terminal receives an RRC release message, where the RRC release message includes a first SRS configuration.

The first SRS configuration includes validity area information, and the validity area information is used for indicating coverage of a second access network device that reserves an SRS resource for the terminal when the terminal is released to an RRC inactive state.

According to a fourth aspect, an SRS configuration apparatus is provided, and is used in a first access network device. The apparatus includes:
a first receiving module, configured to receive a first SRS configuration sent by an LMF.

The first SRS configuration includes validity area information, and the validity area information is used for indicating coverage of a second access network device that reserves an SRS resource for a terminal when the terminal is released to an RRC inactive state.

According to a fifth aspect, an SRS configuration apparatus is provided, and is used in an LMF. The apparatus includes:
a sending module, configured to send a first SRS configuration to a first access network device.

The first SRS configuration includes validity area information, and the validity area information is used for indicating coverage of a second access network device that reserves an SRS resource for a terminal when the terminal is released to an RRC inactive state.

According to a sixth aspect, an SRS configuration apparatus is provided, and is used in a terminal. The apparatus includes:
a second receiving module, configured to receive an RRC release message sent by an LMF, where the RRC release message includes a first SRS configuration.

The first SRS configuration includes validity area information, and the validity area information is used for indicating coverage of a second access network device that reserves an SRS resource for the terminal when the terminal is released to an RRC inactive state.

According to a seventh aspect, a terminal is provided. The terminal includes a processor and a memory. The memory stores a program or instructions runnable on the processor. When the program or the instructions are executed by the processor, a step of the method according to the third aspect is implemented.

According to an eighth aspect, a terminal is provided, and includes a processor and a communication interface. The communication interface is configured to receive an RRC release message sent by an LMF. The RRC release message includes a first SRS configuration. The first SRS configuration includes validity area information, where the validity area information is used for indicating coverage of a second access network device that reserves an SRS resource for the terminal when the terminal is released to an RRC inactive state.

According to a ninth aspect, a network side device is provided. The network side device includes a processor and a memory. The memory stores a program or instructions runnable on the processor. When the program or the instructions are executed by the processor, a step of the method according to the first aspect or the second aspect is implemented.

According to a tenth aspect, a network side device is provided, and includes a processor and a communication interface. The communication interface is configured to receive a first SRS configuration sent by a location management function LMF. The first SRS configuration includes validity area information, where the validity area information is used for indicating coverage of a second access network device that reserves an SRS resource for a terminal when the terminal is released to an RRC inactive state.

Alternatively, the communication interface is configured to send a first SRS configuration to a first access network device. The first SRS configuration includes validity area information, where the validity area information is used for indicating coverage of a second access network device that reserves an SRS resource for a terminal when the terminal is released to an RRC inactive state.

According to an eleventh aspect, a readable storage medium is provided. The readable storage medium stores a program or instructions. When the program or the instructions are executed by a processor, a step of the method according to the first aspect is implemented, or a step of the method according to the second aspect is implemented, or a step of the method according to the third aspect is implemented.

According to a twelfth aspect, a wireless communication system is provided, and includes an access network device, an LMF, and a terminal. The access network device may be configured to perform a step of the method according to the first aspect. The LMF may be configured to perform a step of the method according to the second aspect. The terminal may be configured to perform a step of the method according to the third aspect.

According to a thirteenth aspect, a chip is provided. The chip includes a processor and a communication interface. The communication interface is coupled to the processor. The processor is configured to run a program or instructions, to implement the method according to the first aspect, the second aspect, or the third aspect.

According to a fourteenth aspect, a computer program/program product is provided. The computer program/program product is stored in a storage medium. The computer program/program product is executed by at least one processor, to implement a step of the method according to the first aspect, the second aspect, or the third aspect.

### BRIEF DESCRIPTION OF DRAWINGS

FIG. 1 is a block diagram of a wireless communication system to which an embodiment of this application is applicable;

FIG. 2 is a flowchart 1 of an SRS configuration method according to an embodiment of this application;

FIG. 3 is a flowchart 2 of an SRS configuration method according to an embodiment of this application;

FIG. 4 is a flowchart 3 of an SRS configuration method according to an embodiment of this application;

FIG. 5a is a flowchart 4 of an SRS configuration method according to an embodiment of this application;

FIG. 5b is a flowchart 5 of an SRS configuration method according to an embodiment of this application;

FIG. 5c is a flowchart 6 of an SRS configuration method according to an embodiment of this application;

FIG. 6 is a diagram 1 of a structure of an SRS configuration apparatus according to an embodiment of this application;

FIG. 7 is a diagram 2 of a structure of an SRS configuration apparatus according to an embodiment of this application;

FIG. 8 is a diagram 3 of a structure of an SRS configuration apparatus according to an embodiment of this application;

FIG. 9 is a diagram of a structure of a communication device according to an embodiment of this application;

FIG. 10 is a diagram of a structure of a terminal according to an embodiment of this application;

FIG. 11 is a diagram of a structure of a network side device according to an embodiment of this application; and

FIG. 12 is a diagram of a structure of another network side device according to an embodiment of this application.

### DETAILED DESCRIPTION

The following clearly describes the technical solutions in embodiments of this application with reference to the accompanying drawings in embodiments of this application. It is clear that described embodiments are a part of embodiments of this application rather than all embodiments of this application.

The terms such as “first” and “second” in this application are used to distinguish between similar objects, but are not used to describe a specific sequence or order. It should be understood that the terms used in this way are interchangeable in an appropriate case, so that embodiments of this application may be implemented in a sequence other than those illustrated or described herein. In addition, objects distinguished by using “first” and “second” are generally of the same type and do not limit a quantity of objects. For example, one or more first objects may be arranged. In addition, “or” in this application indicates at least one of connected objects. For example, “A or B” covers three solutions: solution 1: including A and excluding B; solution 2: including B and excluding A; and solution 3: including both A and B. The character “/” usually indicates an “or” relationship between the associated objects.

The term “indication” in this application may be a direct indication (or an explicit indication), or may be an indirect indication (or an implicit indication). The direct indication may be understood as that a sending party clearly notifies, in a sent indication, a receiving party of specific information, an operation needing to be performed, a request result, or the like. The indirect indication may be understood as that a receiving party determines corresponding information based on an indication sent by a sending party, or judges based on the indication sent by the sending party, and determines an operation needing to be performed, a request result, or the like based on a judging result.

It should be noted that, the technology described in embodiments of this application may be applied to a long term evolution (LTE)/LTE-advanced (LTE-A) system, and may be further applied to another wireless communication system, for example, a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. The terms “system” and “network” in embodiments of this application are usually interchangeably used. The described technology may be applied to the system mentioned above and a radio technology, or may be applied to another system and the radio technology. A new radio (NR) system is described below as an example, and the term NR is used in most of the following descriptions. However, these technologies may also be applied to a system other than the NR system, for example, a 6^{th} generation (6G) communication system.

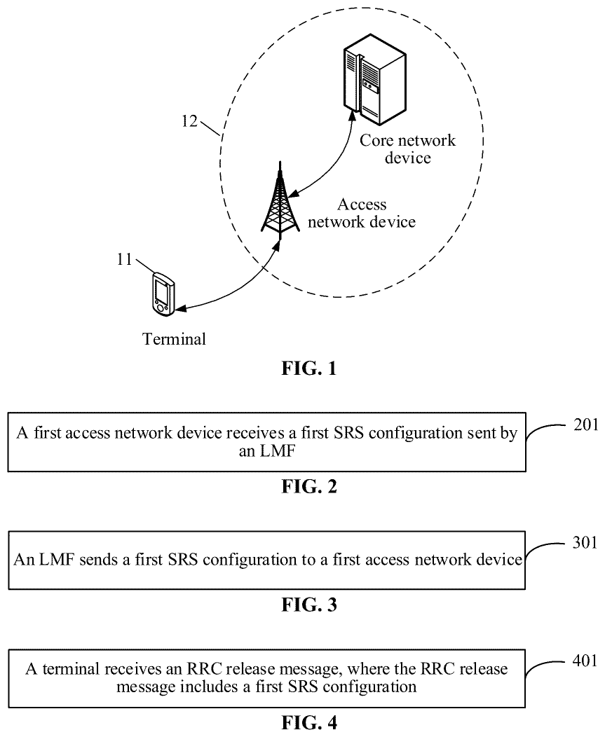

FIG. 1 is a block diagram of a wireless communication system to which an embodiment of this application is applicable. The wireless communication system includes a terminal 11 and a network side device 12. The terminal 11 may be a terminal side device like a mobile phone, a tablet computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, an in-vehicle device (VUE), a shipborne device, a pedestrian terminal (PUE), a smart home appliance (a home device with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The in-vehicle device may also be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay based station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another suitable term in the field, as long as the same technical effect is achieved, and the base station is not limited to a specific technical word. It should be noted that in embodiments of this application, the base station in the NR system is merely used as an example for description, and a specific type of the base station is not limited.

The core network device may include, but is not limited to, at least one of the following: a core network node, a core network function, a location management function (LMF), a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in embodiments of this application, the core network device in the NR system is merely used as an example for description, and a specific type of the core network device is not limited.

The following describes in detail, with reference to the accompanying drawings and through some embodiments and application scenarios of the embodiments, an SRS configuration method and apparatus and a related device that are provided in embodiments of this application.

FIG. 2 is a flowchart 1 of an SRS configuration method according to an embodiment of this application. The method is applied to a first access network device. As shown in FIG. 2, the method includes the following steps.

Step 201: The first access network device receives a first SRS configuration sent by an LMF.

The first SRS configuration includes validity area information, and the validity area information is used for indicating coverage of a second access network device that reserves an SRS resource for a terminal when the terminal is released to an RRC inactive state.

It should be noted that the first access network device is an access network device (for example, a serving base station) currently accessed by the terminal, and the second access network device may be a neighboring access network device (for example, a neighboring base station) of the terminal. Certainly, the first access network device may alternatively be used as a second access network device or a third access network device in some other scenarios, and the second access network device may alternatively be used as a first access network device or a third access network device in some other scenarios.

In this embodiment of this application, the first access network device (namely, the serving base station) receives the first SRS configuration sent by the location management function (LMF). The first SRS configuration includes the validity area information, where the validity area information is used for indicating the coverage of the second access network device that reserves the SRS resource for the terminal when the terminal is released to the RRC inactive (RRC_INACTIVE) state. In this way, the LMF specifies the first SRS configuration and sends the first SRS configuration to the first access network device currently accessed by the terminal, so that the first access network device can learn of coverage of another access network device that reserves an SRS resource for the terminal when the terminal is released to the RRC inactive state. Then, the serving base station can specify, before releasing the terminal to the RRC inactive state, a specific access network device that reserves an SRS resource for the terminal. In this way, when the terminal is released to the RRC inactive state and moves into coverage of the access network device, the terminal can still send an uplink positioning reference signal based on the reserved SRS resource, and the terminal does not need to re-obtain an SRS configuration. In this way, power consumption of the terminal in the inactive state can be reduced.

Optionally, the method further includes the following step.

The first access network device sends an RRC release message to the terminal, where the RRC release message includes the first SRS configuration.

In this embodiment of this application, after the first access network device receives the first SRS configuration sent by the LMF, the first access network device may send the first SRS configuration to the terminal by using the RRC release message. Then, the terminal can learn of the coverage of the second access network device that reserves the SRS resource for the terminal when the terminal is released to the RRC inactive state, in other words, can learn of coverage of a specific access network device within which the terminal may still send an uplink positioning reference signal based on an SRS resource reserved by the access network device when the terminal is released to the RRC inactive state by the first access network device. In this way, when the terminal is released to the RRC inactive state and moves into the coverage of the second access network device, an original SRS configuration is still valid, and the terminal does not need to re-obtain an SRS configuration. In this way, the power consumption of the terminal in the inactive state can be reduced.

It should be noted that the first access network device may send the first SRS configuration and an SRS configuration to the terminal by using the RRC release message. The SRS configuration may be an SRS configuration normally configured by the first access network device for the terminal, for example, may include information such as an SRS transmission periodicity and an SRS transmission start position. The first SRS configuration may be a supplementary configuration for the SRS configuration. In other words, the first SRS configuration is mainly used for indicating the validity area information, in other words, indicating the coverage of the second access network device that reserves the SRS resource for the terminal when the terminal is released to the RRC inactive state, so that the terminal can specify coverage of a specific access network device within which the terminal may still send an SRS based on the SRS configuration.

Optionally, before step 210, the method further includes the following step.

The first access network device receives a first request sent by the LMF, where the first request includes indication information used for indicating whether the first SRS configuration is included.

For example, the LMF may determine, based on a low-power high-accuracy positioning (LPHAP) requirement and a terminal capability, to use uplink positioning based on an uplink positioning reference signal associated with the validity area information. The LMF may send the first request to the first access network device, to request the first access network device to feed back the SRS configuration. The first request includes the indication information used for indicating whether the first SRS configuration (namely, the validity area information) is included. For example, the first request includes indication information used for indicating that the first SRS configuration is included. In other words, the LMF indicates, by using the first request, the first access network device that the first SRS configuration needs to be determined, in other words, the validity area information needs to be determined. In this way, the LMF can determine the corresponding second access network device based on the validity area information fed back by the first access network device, and request the second access network device to reserve the SRS resource.

Optionally, the first request includes at least one of the following:
first indication information, where the first indication information is used for indicating an RRC state requirement of LPHAP of the terminal, for example, the RRC inactive (RRC_INACTIVE) state or an RRC idle (RRC_IDLE) state; and
second indication information, where the second indication information is used for indicating whether the first SRS configuration is included, in other words, whether the validity area information is included.

Optionally, when the first request includes the first indication information, the first indication information indicates that the RRC state requirement of the LPHAP of the terminal is the RRC inactive state, and the first request includes an SRS configuration request, the first indication information is further used for indicating the indication information indicating whether the first SRS configuration is included. In other words, the first indication information implicitly includes the second indication information, to implicitly indicate whether the first SRS configuration is included, in other words, whether the validity area information is included. In other words, the second indication information explicitly indicates whether the first SRS configuration is included.

It should be noted that, the SRS configuration request is a requested SRS characteristic. The first request includes the SRS configuration request. In other words, the first request includes the requested SRS characteristic.

In this embodiment of this application, when the first request includes the first indication information, the RRC state requirement of the LPHAP of the terminal is indicated, so that the first access network device can release, based on the first indication information, the terminal to an RRC state meeting the LPHAP requirement, for example, the RRC inactive state or the RRC idle state.

When the first request includes the second indication information, or when the first indication information implicitly indicates whether the validity area information is included, before releasing the terminal to the RRC unconnected state, the first access network device further needs to obtain the first SRS configuration, in other words, obtain the validity area information.

Optionally, after the first access network device receives the first request sent by the LMF, the method further includes the following step.

The first access network device determines a second SRS configuration based on the first request, and sends the second SRS configuration to the LMF, where the second SRS configuration includes at least one of the following:
third indication information, where the third indication information is used for indicating that an RRC state to which the terminal is to be released is the RRC inactive state or an RRC idle state; and
fourth indication information, where the fourth indication information is used for indicating to request the first SRS configuration.

In this embodiment of this application, after receiving the first request sent by the LMF, the first access network device determines the second SRS configuration based on the first request. For example, the first access network device may determine the second SRS configuration based on the first indication information and/or the second indication information.

It should be noted that, when the first request includes the first indication information, the first access network device may determine, based on the first indication information, to release the terminal to the RRC inactive state or the RRC idle state, and perform feedback by using the third indication information. In other words, the second SRS configuration includes the third indication information. In this way, the LMF can learn that the terminal is to be released to the RRC inactive state or the RRC idle state.

When the first request includes the second indication information, or when the first indication information is used for indicating whether the validity area information is included, the first access network device indicates, by using the fourth indication information, to request to obtain the first SRS configuration, in other words, request to obtain the validity area information. It should be noted that, the second SRS configuration sent by the first access network device to the LMF includes the fourth indication information, so that the first access network device can notify, by using the fourth indication information, the LMF of a specific area in which the first access network device expects the terminal to be released to the RRC inactive state and the SRS configuration of the terminal is still valid, in other words, a specific validity area in which an SRS resource is reserved for the terminal.

In this embodiment of this application, after receiving the second SRS configuration sent by the first access network device, the LMF sends a fourth request to the second access network device within a validity area, to request the second access network device to reserve the SRS resource. Optionally, the fourth request may include at least one of the following:
a transmission reception point (TRP) identifier, used for uniquely identifying a TRP of an access network device;
a cell identifier, used for uniquely identifying a cell, for example, an NR cell global identifier (NCGI);
a resource reservation identifier, used for uniquely identifying a group of reserved SRS configuration resources;
SRS configuration information; and
a request type, namely, reserve or release.

Further, the second access network device that receives the fourth request determines whether to agree to reserve the SRS resource, and sends a second response to the LMF, where the second response includes at least one of the following:
a response type, namely, agree or reject;
system frame number (SFN) initialization time when the response type is agree; and
a reject reason when the response type is reject.

It may be understood that after receiving the second response, the LMF can learn of a specific second access network device that agrees to reserve an SRS resource. Then, the LMF can determine the validity area information based on the second access network device that agrees to reserve the SRS resource. For example, coverage of the second access network device that agrees to reserve the SRS resource is the validity area, or a cell that agrees to reserve the SRS resource is used as a cell in the validity area.

In this embodiment of this application, after determining the validity area information, the LMF sends the first SRS configuration to the first access network device. In other words, the first SRS configuration includes the validity area information. In this way, the first access network device can specify coverage of another access network device that reserves an SRS resource for the terminal when the terminal is released to the RRC inactive state. In this way, when the terminal moves into the coverage of the access network device, the terminal can still send an uplink positioning reference signal based on the reserved SRS resource.

Optionally, when the terminal moves out of an area indicated by the validity area information, in other words, moves out of the coverage of the second access network device that reserves the SRS resource, the terminal releases the SRS configuration and the first SRS configuration. If the terminal needs to continue to send an SRS, the terminal initiates small data transmission (SDT) and sends an RRC resume request message. A condition or a reason for the terminal to trigger the SDT may be that signaling is sent on an RRC layer to request to resume an RRC connection. In this case, the terminal sends a message to an access network device newly accessed by the terminal, to indicate that the terminal needs to update the SRS configuration.

Optionally, before the terminal moves out of the area indicated by the validity area information and the first access network device receives the first SRS configuration sent by the LMF, where the first access network device may be the access network device (namely, a new base station) newly accessed by the terminal, the method further includes the following step.

The first access network device receives a second request sent by the terminal, where the second request is used for requesting to resume the RRC connection.

In other words, the terminal requests the access network device newly accessed by the terminal to resume the RRC connection.

Optionally, the second request includes fifth indication information, and the fifth indication information is used for indicating that the terminal needs to update the SRS configuration.

Alternatively, after the first access network device receives the second request sent by the terminal, the method further includes the following step.

The first access network device receives a first message sent by the terminal, where the first message includes fifth indication information.

Alternatively, that the first access network device receives the second request sent by the terminal includes:

The first access network device receives the second request and a first message that are sent by the terminal, where the first message includes fifth indication information.

The fifth indication information is used for indicating that the terminal needs to update the SRS configuration.

In other words, the terminal may send the first message to the first access network device after sending the second request to the first access network device, to indicate that the terminal needs to update the SRS configuration. Alternatively, the first message and the second request may be sent to the first access network device together. For example, the fifth indication information may be included in the RRCResumeRequest message for sending. A dedicated logical channel identity (LCID) or an extended LCID (eLCID) may be used in a medium access control (MAC) header of a message A (MSGA) or a message 3 (MSG3).

Optionally, after the first access network device receives the second request sent by the terminal, the method further includes the following step.

The first access network device sends a third request to a third access network device, where the third request is used for indicating that the terminal needs to update the SRS configuration.

The third access network device is an original access network device of the terminal.

In other words, the new serving base station of the terminal sends the third request to the original serving base station. For example, the third request may be a retrieve terminal context request (RETRIEVE UE CONTEXT REQUEST). The third request is used for indicating a resume reason of the terminal, namely, the terminal needing to update the SRS configuration.

Further, after the first access network device sends the third request to the third access network device, the method further includes the following step.

The first access network device receives a first response sent by the third access network device, where the first response includes at least one of the following:
sixth indication information, where the sixth indication information is used for indicating the RRC state requirement of the LPHAP of the terminal; and
seventh indication information, where the seventh indication information is used for indicating whether the first SRS configuration is included.

For example, the original serving base station learns, based on the third request sent by the new serving base station, that the terminal needs to update the SRS configuration. The original serving base station feeds back the first response to the new serving base station. For example, the first response may be a retrieve terminal context response (RETRIEVE UE CONTEXT RESPONSE). The response includes at least one of the sixth indication information and the seventh indication information. In other words, the sixth indication information is used for notifying the new serving base station of the RRC state requirement of the LPHAP of the terminal, and the seventh indication information is used for notifying whether the first SRS configuration is included, in other words, whether the validity area information is included.

It should be noted that, the first response may further include the requested SRS characteristic and the previously configured SRS configuration, namely, the SRS configuration sent by the original serving base station to the terminal. When the original serving base station includes the first SRS configuration, the first response may further include the first SRS configuration, so that the new serving base station can learn of the validity area information.

Further, the new base station determines a new SRS configuration based on the requested SRS characteristic and the previously configured SRS configuration.

Optionally, after the first access network device receives the first response sent by the third access network device, and before the first access network device receives the first SRS configuration sent by the LMF, the method further includes the following step.

The first access network device sends first update information to the LMF, where the first update information includes at least one of the following:
eighth indication information, where the eighth indication information is used for indicating that the RRC state to which the terminal is to be released is the RRC inactive state or the RRC idle state; and
ninth indication information, where the ninth indication information is used for indicating to request the first SRS configuration.

For example, after determining the new SRS configuration, the first access network device (namely, the new serving base station) sends first update information to the LMF, to update the SRS configuration. The first update information includes at least one of the eighth indication information and the ninth indication information. For example, the first update information includes the eighth indication information. In other words, the LMF is notified that the terminal is to be released to the RRC inactive state or the RRC idle state, so that the LMF can learn of the RRC state of the terminal. If the first update information includes the ninth indication information, the new serving base station requests, from the LMF, to obtain the first SRS configuration, in other words, obtain the validity area information.

Further, the LMF negotiates SRS resource reservation with a neighboring base station of the new serving base station based on the first update information, to determine a neighboring base station that can reserve an SRS resource for the new base station, and determine the validity area information, in other words, determine the first SRS configuration. Then, the LMF sends the first SRS configuration to the new serving base station (namely, the first access network device). In this way, the new serving base station can obtain the validity area information, to specify coverage of an access network device that reserves an SRS resource for the terminal when the terminal is released to the RRC inactive state, in other words, specify a specific access network device that reserves an SRS resource for the terminal.

Optionally, the LMF may send a resource reservation release message to base stations (including the original serving base station and the neighboring base station) that reserve the SRS resource previously, where the resource reservation release message includes at least one of the following:
a TRP identifier, used for uniquely identifying a TRP of an access network device;
a cell identifier, used for uniquely identifying a cell, for example, an NCGI;
a resource reservation identifier, used for uniquely identifying a group of reserved SRS configuration resources;
SRS configuration information; and
a message type, namely, reserve or release.

In this embodiment of this application, when the first access network device is the access network device newly accessed by the terminal, the terminal sends the second request to the first access network device, to request to resume the RRC connection; After receiving the second request, the first access network device sends the third request to the third access network device (namely, the original serving base station), to indicate that the terminal needs to update the SRS configuration. Further, after the first access network device sends the third request to the third access network device, the method further includes the following step.

The first access network device receives a part of terminal context sent by the third access network device.

For example, the third access network device (namely, the original serving base station) decides to store a terminal context (UE context), and sends a part of the UE context to the first access network device.

Optionally, the part of terminal context includes at least one of the following:
a requested SRS characteristic; and
a configured SRS configuration, namely, the previously configured SRS configuration.

Further, after the first access network device receives the part of terminal context sent by the third access network device, the method further includes the following step.

The first access network device sends a third SRS configuration to the third access network device, where the third SRS configuration includes at least one of the following:
a TRP identifier, used for uniquely identifying a TRP of an access network device;
a cell identifier, used for uniquely identifying a cell, for example, an NCGI; and
SRS configuration information, for example, including an SRS transmission periodicity.

For example, after receiving the part of terminal context sent by the original serving base station, the new serving base station determines a new SRS configuration (namely, the third SRS configuration), and feeds back the third SRS configuration to the original serving base station. In this way, the original serving base station can obtain the new SRS configuration.

Further, the third access network device (namely, the original serving base station) sends a location information update message to the LMF, to update the SRS configuration, where the message may include at least one of the following:
a cell identifier, used for indicating a current camping cell of the terminal; and
SRS configuration information, where the SRS configuration information may include, for example, an SRS transmission periodicity.

The LMF negotiates SRS resource reservation with a neighboring base station of the new serving base station based on the location information update message, to determine a neighboring base station that can reserve an SRS resource for the new base station, and determine the validity area information, in other words, determine the first SRS configuration. Then, the LMF sends the first SRS configuration to the new serving base station (namely, the first access network device). In this way, the new serving base station can obtain the validity area information, to specify coverage of an access network device that reserves an SRS resource for the terminal when the terminal is released to the RRC inactive state, in other words, specify a specific access network device that reserves an SRS resource for the terminal.

Optionally, after the first access network device sends the third SRS configuration to the third access network device, the method further includes the following steps.

The first access network device ends, when there is no data to be sent, the small data transmission SDT.

The first access network device receives an RRC release message sent by the third access network device, where the RRC release message includes the first SRS configuration.

For example, if having no data to be sent, the new serving base station ends the SDT. The original serving base station sends, to the new serving base station, the RRC release message carrying the SRS configuration and the first SRS configuration. The new serving base station sends the SRS configuration and the first SRS configuration to the terminal by using the RRC release message.

FIG. 3 is a flowchart 2 of an SRS configuration method according to an embodiment of this application. The method is applied to an LMF. As shown in FIG. 3, the method includes the following steps.

Step 301: The LMF sends a first SRS configuration to a first access network device.

The first SRS configuration includes validity area information, and the validity area information is used for indicating coverage of a second access network device that reserves an SRS resource for a terminal when the terminal is released to an RRC inactive state.

In this embodiment of this application, the LMF determines the first SRS configuration, and sends the first SRS configuration to the first access network device currently accessed by the terminal, so that the first access network device can learn of coverage of another access network device that reserves an SRS resource for the terminal when the terminal is released to the RRC inactive state. Then, a serving base station can specify, before releasing the terminal to the RRC unconnected state, a specific access network device that reserves an SRS resource for the terminal. In this way, when the terminal is released to the RRC inactive state and moves into coverage of the access network device, the terminal can still send an uplink positioning reference signal based on the reserved SRS resource, and the terminal does not need to re-obtain an SRS configuration. In this way, power consumption of the terminal in the inactive state can be reduced.

It should be noted that, after receiving the first SRS configuration, the first access network device may send an RRC release message to the terminal, where the RRC release message includes the first SRS configuration. In this way, the terminal can learn of a specific access network device that reserves an SRS resource for the terminal when the terminal is released to the RRC inactive state, and an original SRS configuration of the terminal is still valid within coverage of the access network device. In this way, it is ensured that the terminal can send an SRS within the coverage of the access network device without re-obtaining an SRS configuration, so that the power consumption of the terminal is effectively reduced.

Optionally, in this embodiment of this application, before step 301, the method further includes the following step.

The LMF sends a first request to the first access network device, where the first request includes indication information used for indicating whether the first SRS configuration is included.

Optionally, the first request includes at least one of the following:
first indication information, where the first indication information is used for indicating an RRC state requirement of LPHAP of the terminal; and
second indication information, where the second indication information is used for indicating whether the first SRS configuration is included.

Optionally, when the first request includes the first indication information, the first indication information indicates that the RRC state requirement of the LPHAP of the terminal is the RRC inactive state, and the first request includes an SRS configuration request, the first indication information is further used for indicating the indication information indicating whether the first SRS configuration is included.

For example, the LMF may determine, based on the requirement of the LPHAP and a terminal capability, to use uplink positioning based on an uplink positioning reference signal associated with the validity area information. The LMF may send the first request to the first access network device, to request the first access network device to feed back an SRS configuration. For example, the first request includes indication information used for indicating that the first SRS configuration is included. In other words, the LMF indicates, by using the first request, the first access network device to determine the first SRS configuration, in other words, to determine the validity area information. In this way, the LMF can determine the corresponding second access network device based on the validity area information fed back by the first access network device, and request the second access network device to reserve the SRS resource.

In this embodiment of this application, the indication information indicating whether the first SRS configuration is included may be directly indicated by using the second indication information, or may be implicitly indicated by using the first indication information.

Optionally, after the LMF sends the first request to the first access network device, the method further includes the following step.

The LMF receives a second SRS configuration sent by the first access network device, where the second SRS configuration includes at least one of the following:
third indication information, where the third indication information is used for indicating that an RRC state to which the terminal is to be released is the RRC inactive state or an RRC idle state; and
fourth indication information, where the fourth indication information is used for indicating to request the first SRS configuration.

In this embodiment of this application, after receiving the first request sent by the LMF, the first access network device determines the second SRS configuration based on the first request. For example, the first access network device may determine the second SRS configuration based on at least one of the first indication information and the second indication information.

Optionally, after the LMF receives the second SRS configuration sent by the first access network device, the method further includes the following step.

The LMF sends a fourth request to the second access network device, where the fourth request is used for requesting to reserve the SRS resource.

The fourth request includes at least one of the following:
a TRP identifier;
a cell identifier, for example, an NCGI;
a resource reservation identifier;
SRS configuration information; and
a request type, namely, reserve or release.

It should be noted that the second access network device may be a neighboring access network device of the first access network device.

For example, the LMF receives the second SRS configuration sent by the first access network device. The second SRS configuration includes the fourth indication information. In other words, the first access network device requests to obtain the first SRS configuration, in other words, obtain the validity area information. In this way, the LMF may send the fourth request to the neighboring second access network device, to request the second access network device to reserve the SRS resource. In this way, the LMF can determine the validity area information depending on whether the second access network device reserves the SRS resource, and feed back the validity area information to the first access network device.

Optionally, after the LMF sends the fourth request to the second access network device, the method further includes the following step.

The LMF receives a second response sent by the second access network device, and determines the validity area information based on the second response, where the second response includes at least one of the following:
a response type, namely, agree or reject;
SFN initialization time when the response type is agree; and
a reject reason when the response type is reject.

It may be understood that after receiving the fourth request for requesting to reserve the SRS resource, the second access network device may agree to reserve the SRS resource, or may reject to reserve the SRS resource. Optionally, the LMF device may send the fourth request to a plurality of neighboring second access network devices, and can receive a second response fed back by each second access network device, so that the LMF can learn of a specific second access network device that agrees to reserve an SRS resource. Then, the LMF can determine the validity area information based on the second access network device that agrees to reserve the SRS resource. For example, coverage of the second access network device that agrees to reserve the SRS resource is a validity area, or a cell that agrees to reserve the SRS resource is used as a cell in the validity area.

If the response type is agree, the second response further includes the SFN initialization time. If the response type is reject, the second response further includes the reject reason, to help the LMF subsequently determine the validity area information. For example, a second access network device that rejects to reserve the SRS resource may not be considered.

In this embodiment of this application, when the terminal moves out of an area indicated by the validity area information and the first access network device is an access network device newly accessed by the terminal, that the LMF receives the second SRS configuration sent by the first access network device includes:
The LMF receives first update information sent by the first access network device, where the first update information includes the second SRS configuration.

It should be noted that, if the terminal moves out of the area indicated by the validity area information, for example, moves out of the coverage of the second access network device, the terminal re-accesses a new access network device. In this case, the first access network device is the access network device newly accessed by the terminal. For interaction between the first access network device (namely, a new serving base station) and a third access network device (namely, an original serving base station), refer to the descriptions of the embodiment in FIG. 2. Details are not described herein again.

In this case, if the first access network device (namely, the new serving base station) needs to update the SRS configuration, the first access network device determines, based on a requested SRS characteristic sent by the original serving base station and information about a configured SRS configuration, a new SRS configuration, namely, the second SRS configuration. Further, the first access network device sends first update information to the LMF, to update the SRS configuration. The first update information includes the second SRS configuration, in other words, includes at least one of the third indication information and the fourth indication information. For example, if the second SRS configuration includes the third indication information, the LMF is notified that the terminal is to be released to the RRC inactive state or the RRC idle state, so that the LMF can learn of the RRC state of the terminal. If the second SRS configuration includes the fourth indication information, the new serving base station requests, from the LMF, to obtain the first SRS configuration, in other words, obtain the validity area information.

Further, the LMF negotiates SRS resource reservation with a neighboring base station (namely, the second access network device) of the new serving base station (namely, the first access network device) based on the first update information, to determine a neighboring base station that can reserve an SRS resource for the new base station, and determine the validity area information, in other words, determine the first SRS configuration. Then, the LMF sends the first SRS configuration to the new serving base station (namely, the first access network device). In this way, the new serving base station can obtain the validity area information, to specify coverage of an access network device that reserves an SRS resource for the terminal when the terminal is released to the RRC inactive state, in other words, specify a specific access network device that reserves an SRS resource for the terminal.

Optionally, after the LMF sends the first SRS configuration to the first access network device, the method further includes the following step.

The LMF sends a resource reservation release message to the third access network device, where the third access network device is the original access network device of the terminal, and the resource reservation release message includes at least one of the following:
a TRP identifier;
a cell identifier, for example, an NCGI;
a resource reservation identifier;
SRS configuration information; and
a message type, namely, reserve or release.

It should be noted that the LMF may send the resource reservation release message to the third access network device (namely, the original serving base station) and a neighboring access network device of the third access network device. The neighboring access network device may be an access network device that is determined when the terminal accesses the third access network device and that has reserved an SRS resource for the terminal when the terminal is released to the RRC inactive state.

The SRS configuration method provided in this embodiment of this application is applied to the LMF, and corresponds to the foregoing SRS configuration method applied to the first access network device. For a related concept and a specific procedure related in this embodiment of this application, refer to the descriptions of the method embodiment in FIG. 2. To avoid repetition, details are not described in this embodiment again.

FIG. 4 is a flowchart 3 of an SRS configuration method according to an embodiment of this application. The method is applied to a terminal. As shown in FIG. 4, the method includes the following steps.

Step 401: The terminal receives an RRC release message, where the RRC release message includes a first SRS configuration.

The first SRS configuration includes validity area information, and the validity area information is used for indicating coverage of a second access network device that reserves an SRS resource for the terminal when the terminal is released to an RRC inactive state.

It should be noted that a first access network device is an access network device currently accessed by the terminal, and the second access network device is a neighboring access network device (for example, a neighboring base station) of the terminal.

In this embodiment of this application, the terminal can learn, by using the RRC release message, of the coverage of the second access network device that reserves the SRS resource for the terminal when the terminal is released to the RRC inactive state, in other words, can learn of coverage of a specific access network device within which the terminal may still send an uplink positioning reference signal based on an SRS resource reserved by the access network device when the terminal is released to the RRC inactive state by the first access network device. In this way, when the terminal is released to the RRC inactive state and moves into the coverage of the second access network device, the original SRS configuration is still valid, and the terminal does not need to re-obtain an SRS configuration. In this way, power consumption of the terminal in the inactive state can be reduced.

Optionally, the terminal may receive the RRC release message sent by an LMF.

Optionally, when the terminal moves out of an area indicated by the validity area information, the method further includes the following step.

The terminal sends a second request to the first access network device, where the second request is used for requesting to resume an RRC connection, and the first access network device is the access network device newly accessed by the terminal.

Optionally, the second request includes fifth indication information.

Alternatively, after the terminal sends the second request to the first access network device, the method further includes the following step.

The terminal sends a first message to the first access network device, where the first message includes fifth indication information.

Alternatively, that the terminal sends the second request to the first access network device includes:

The terminal sends the second request and a first message to the first access network device, where the first message includes fifth indication information.

The fifth indication information is used for indicating that the terminal needs to update the SRS configuration.

For example, the terminal may send the first message to the first access network device after sending the second request to the first access network device, to indicate that the terminal needs to update the SRS configuration. Alternatively, the first message and the second request may be sent to the first access network device together. For example, the fifth indication information may be included in an RRCResumeRequest message for sending. A dedicated LCID or eLCID may be used in a MAC header of a message A (MSGA) or a message 3 (MSG3).

It should be noted that the SRS configuration method provided in this embodiment of this application is applied to the terminal, and corresponds to the foregoing SRS configuration method applied to the first access network device and the foregoing SRS configuration method applied to the LMF. For a related concept and a specific procedure related in this embodiment of this application, refer to the descriptions of the method embodiment in FIG. 2. To avoid repetition, details are not described in this embodiment again.

For better understanding, the following describes, through several specific embodiments, the SRS configuration method provided in this application.

### Embodiment 1

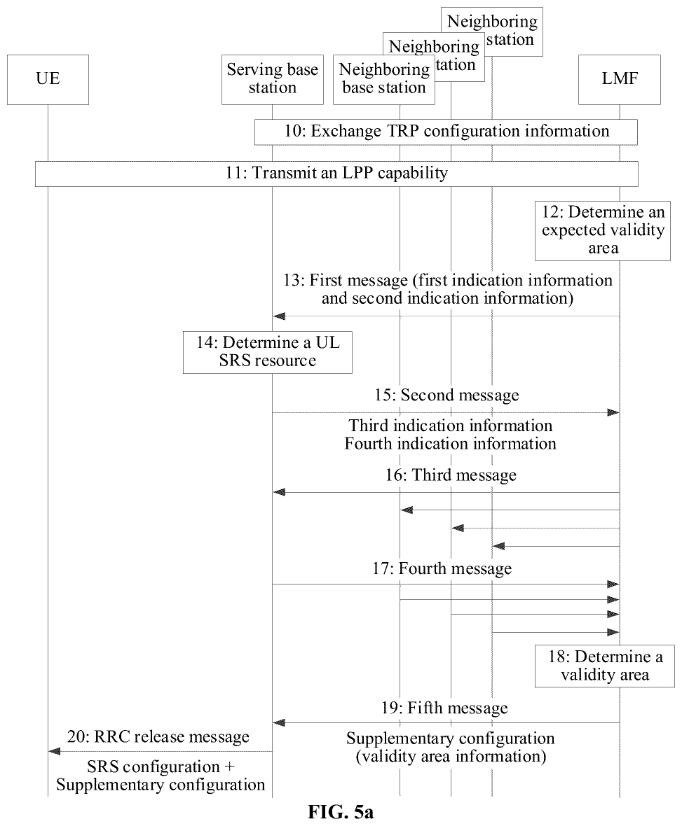

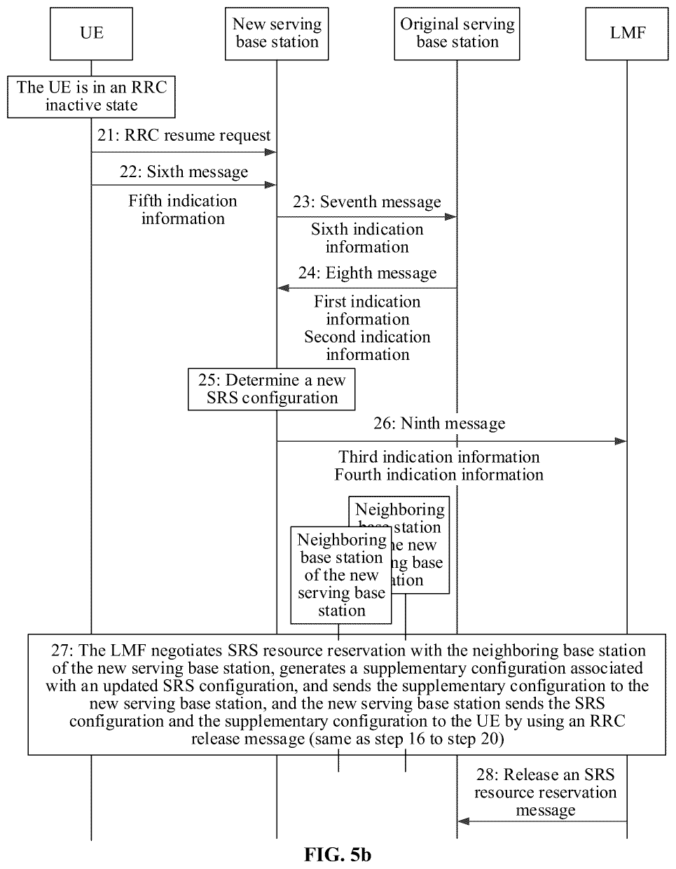

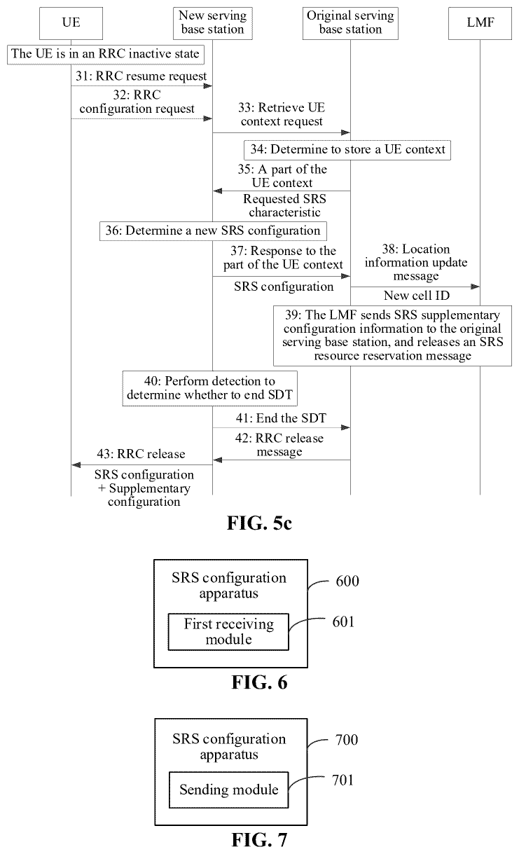

FIG. 5a is a flowchart 4 of an SRS configuration method according to an embodiment of this application. The method includes the following steps.

Step 10: An LMF exchanges, for example, by using NRPPa TRP Configuration Exchange, TRP configuration information with a serving base station and a neighboring base station that are of UE.

Step 11: The UE performs LTE positioning protocol (LPP) capability transfer (LPP capability transfer) with the LMF.

Step 12: The LMF determines, based on a requirement of LPHAP positioning and a terminal capability, to use uplink positioning based on an uplink positioning reference signal associated with a supplementary configuration (namely, a first SRS configuration, including validity area information), and determines an expected validity area based on a serving cell.

Step 13: The LMF sends an SRS configuration request to the serving base station by using a first message (which may be RPPa POSITIONING INFORMATION REQUEST), where at least one of the following is included:

first indication information, used for indicating an RRC state requirement (RRC_INACTIVE and RRC_IDLE) of LPHAP positioning of target UE; and
second indication information, used for indicating whether there is an uplink positioning reference signal supplementary configuration (for example, the validity area information).

Particularly, when the first message includes the first indication information, the first indication information indicates that the RRC state requirement of the LPHAP positioning of the target UE is an RRC_INACITVE state, and the first message includes an uplink positioning reference signal configuration request Requested SRS characteristic, a second information may further be implicitly included.

Step 14: After receiving the SRS configuration request, the serving base station determines an SRS resource configuration. When the serving base station releases the UE to the unconnected state, the indication information in step 13 needs to be considered.

The serving base station releases, based on the first indication information, the UE to a corresponding RRC state, namely, RRC_INACTIVE or RRC_IDLE.

Based on the second indication information, before releasing the UE to the unconnected state, the base station needs to obtain a supplementary configuration sent by the LMF.

Step 15: The serving base station feeds back the determined SRS resource configuration to the LMF by using a second message (which may be RPPa POSITIONING INFORMATION RESPONSE), where at least one of the following is included:
third indication information, used for indicating that an RRC state to which the target UE is to be released is RRC_INACTIVE or RRC_IDLE; and
fourth indication information, used for indicating to request the uplink positioning reference signal supplementary configuration (for example, the validity area information).

Step 16: The LMF sends a third message to a base station in the expected validity area, to request to reserve an SRS resource, where at least one of the following is included:
a TRP ID, used for uniquely identifying a TRP of a base station;
a cell ID, used for uniquely identifying a cell, for example, an NCGI;
a resource reservation ID, used for uniquely identifying a group of reserved SRS configuration resources;
an SRS Configuration; and
a request type, namely, reserve or release.

Step 17: The base station that receives the request in step 16 feeds back, by using a fourth message, whether the base station agrees to reserve the SRS resource, where at least one of the following is included:
a feedback type, namely, agree/respond or reject/fail;
SFN initialization time, namely, SFN Initialization Time that may be further included if the feedback type is agree/respond; and
a failure reason that may be further included if the feedback type is reject/fail.

Step 18: The LMF determines a validity area based on a feedback result. In an implementation, a cell that agrees to reserve an SRS resource may be used as a cell in the validity area.

Step 19: The LMF sends the supplementary configuration to the serving base station by using a fifth message (which may be RPPa POSITIONING INFORMATION REQUEST), where the supplementary configuration includes the validity area information.

Step 20: The serving base station sends the SRS configuration and the supplementary configuration to the UE by using an RRC release message.

### Embodiment 2

FIG. 5b is a flowchart 5 of an SRS configuration method according to an embodiment of this application. The method includes the following steps.

UE is in an RRC inactive state.

Step 21: When the UE moves out of a validity area of an SRS configuration, the UE releases the SRS configuration and a supplementary configuration. If the UE still needs to continue to send an SRS, the UE initiates SDT (a condition/reason for triggering the SDT is added: signaling being sent at an RRC layer to request to resume an RRC connection), and sends an RRCResumeRequest message.

Step 22: The UE sends a sixth message to a new base station, where at least one of the following is included:
fifth indication information, used for indicating that the UE needs to update the SRS configuration.

Particularly, the sixth message may be UE assistance information.

Particularly, the sixth message and the message in step 21 may be sent to the base station together.

Particularly, the fifth indication information may be included in the RRCResumeRequest message in the first step for sending. At least one of the following manners is included.

A dedicated LCID or eLCID is used in a MAC header of a MSGA/MSG3.

Step 23: The new base station sends a seventh message (which may be RETRIEVE UE CONTEXT REQUEST) to an original serving base station, where at least one of the following is included:
sixth indication information, used for indicating a resume reason of the target UE, in other words, the target UE needing to update the SRS configuration.

Step 24: The original serving base station sends an eighth message (which may be RETRIEVE UE CONTEXT RESPONSE) to the new serving base station based on the resume reason indicated by the sixth indication information being that the UE needs to update the SRS configuration, where at least one of the following is included:
first indication information, used for indicating an RRC state requirement (RRC_INACTIVE or RRC_IDLE) of LPHAP positioning of the target UE;
second indication information, used for indicating whether there is an uplink positioning reference signal supplementary configuration (for example, validity area information);
a requested SRS characteristic; and
a previously configured SRS configuration.

Step 25: The new base station determines a new SRS configuration based on the requested SRS characteristic and the previously configured SRS configuration.

Step 26: The new base station sends a ninth message (which may be RPPa POSITIONING INFORMATION UPDATE) to an LMF, to update the SRS configuration, where at least one of the following is included:
third indication information, used for indicating that an RRC state to which the target UE is to be released is RRC_INACTIVE or RRC_IDLE; and
fourth indication information, used for indicating to request the uplink positioning reference signal supplementary configuration (for example, the validity area information).

Step 27: An updated SRS configuration may be sent to the UE based on step 16 to step 20 in FIG. 5a. In other words, the LMF negotiates SRS resource reservation with a neighboring base station of the new base station, generates a supplementary configuration associated with the updated SRS configuration, and sends the supplementary configuration to the new base station. The new base station sends the SRS configuration and the supplementary configuration to the UE by using RRC release.

Step 28: The LMF sends a resource reservation release message to base stations (including the original base station and the neighboring base station) that have reserved the SRS resource previously, where at least one of the following is included:
a TRP ID, used for uniquely identifying a TRP of a base station;
a cell ID, used for uniquely identifying a cell, for example, an NCGI;
a resource reservation ID, used for uniquely identifying a group of reserved SRS configuration resources;
an SRS Configuration; and
a request type, namely, reserve or release.

### Embodiment 3

FIG. 5c is a flowchart 6 of an SRS configuration method according to an embodiment of this application. The method includes the following steps.

Steps 31 to 33 are the same as steps 21 to 23 in FIG. 5b. Details are not described herein again.

Step 34: The original base station decides to store a UE context, and sends a part of the UE context to the new base station.

Step 35: The original base station includes, in PARTIAL UE CONTEXT TRANSFER, at least one of the following:
a requested SRS characteristic; and
a previously configured SRS configuration.

Step 36: The new base station determines a new SRS configuration based on a request.

Step 37: The new base station feeds back, in RETRIEVE UE CONTEXT ACKNOWLEDGE, a corresponding SRS configuration, where at least one of the following is included:
a TRP ID, used for uniquely identifying a TRP of a base station;
a cell ID, used for uniquely identifying a cell, for example, an NCGI; and
an SRS Configuration.

Step 38: The original base station sends RPPa POSITIONING INFORMATION UPDATE to an LMF, and updates the SRS configuration, where at least one of the following is included:
a Cell ID, used for uniquely identifying a cell of a base station, and used for indicating a current camping cell of the UE; and
an SRS Configuration.

Step 39: Send SRS supplementary configuration information to the original base station based on steps 16 to 19 in FIG. 5a. In other words, the LMF negotiates SRS resource reservation with a neighboring base station of the new base station, generates a supplementary configuration associated with an updated SRS configuration, and sends the supplementary configuration to the original base station. In addition, based on step 28 in FIG. 5b, a resource reservation release message is sent to base stations (including the original base station and the neighboring base station) that have reserved an SRS resource previously.

Step 40 to step 41: The new base station ends SDT when there is no data to be sent.

Step 42: The original base station sends, to the new base station, an RRC release message carrying the SRS configuration and the supplementary configuration.

Step 43: The new base station sends the SRS configuration and the supplementary configuration to the UE by using the RRC release message.

An execution body of the SRS configuration method provided in embodiments of this application may be an SRS configuration apparatus. In embodiments of this application, an example in which the SRS configuration apparatus performs the SRS configuration method is used to describe the SRS configuration apparatus provided in embodiments of this application.

FIG. 6 is a diagram 1 of a structure of an SRS configuration apparatus according to an embodiment of this application. The apparatus is used in a first access network device. As shown in FIG. 6, the SRS configuration apparatus 600 includes:
a first receiving module 601, configured to receive a first SRS configuration sent by an LMF.

The first SRS configuration includes validity area information, and the validity area information is used for indicating coverage of a second access network device that reserves an SRS resource for a terminal when the terminal is released to an RRC inactive state.

Optionally, the apparatus further includes:
a sending module, configured to send an RRC release message to the terminal, where the RRC release message includes the first SRS configuration.

Optionally, the first receiving module 601 is further configured to perform the following operation.

The first access network device receives a first request sent by the LMF, where the first request includes indication information used for indicating whether the first SRS configuration is included.

Optionally, the first request includes at least one of the following:
first indication information, where the first indication information is used for indicating an RRC state requirement of low-power high-accuracy positioning LPHAP of the terminal; and
second indication information, where the second indication information is used for indicating whether the first SRS configuration is included.

Optionally, when the first request includes the first indication information, the first indication information indicates that the RRC state requirement of the LPHAP of the terminal is the RRC inactive state, and the first request includes an SRS configuration request, the first indication information is further used for indicating the indication information indicating whether the first SRS configuration is included.

Optionally, the sending module is further configured to:
determine a second SRS configuration based on the first request, and send the second SRS configuration to the LMF, where the second SRS configuration includes at least one of the following:
third indication information, where the third indication information is used for indicating that an RRC state to which the terminal is to be released is the RRC inactive state or an RRC idle state; and
fourth indication information, where the fourth indication information is used for indicating to request the first SRS configuration.

Optionally, if the terminal moves out of an area indicated by the validity area information and the first access network device is an access network device newly accessed by the terminal, the first receiving module 601 is further configured to:
receive a second request sent by the terminal, where the second request is used for requesting to resume an RRC connection.

Optionally, the second request includes fifth indication information.

Alternatively, the first receiving module 601 is further configured to perform the following operation.

The first access network device receives a first message sent by the terminal, where the first message includes fifth indication information.

Alternatively, the first receiving module 601 is further configured to perform the following operation.

The first access network device receives the second request and a first message that are sent by the terminal, where the first message includes fifth indication information.

The fifth indication information is used for indicating that the terminal needs to update the SRS configuration.

The sending module is further configured to:
send a third request to a third access network device, where the third request is used for indicating that the terminal needs to update an SRS configuration.

The third access network device is an original access network device of the terminal.

Optionally, the first receiving module 601 is further configured to:
receive a first response sent by the third access network device, where the first response includes at least one of the following:
sixth indication information, where the sixth indication information is used for indicating the RRC state requirement of the LPHAP of the terminal; and
seventh indication information, where the seventh indication information is used for indicating whether the first SRS configuration is included.

Optionally, the sending module is further configured to:
send first update information to the LMF, where the first update information includes at least one of the following:
eighth indication information, where the eighth indication information is used for indicating that the RRC state to which the terminal is to be released is the RRC inactive state or the RRC idle state; and
ninth indication information, where the ninth indication information is used for indicating to request the first SRS configuration.

Optionally, the first receiving module 601 is further configured to:
receive a part of terminal context sent by the third access network device.

Optionally, the part of terminal context includes at least one of the following:
a requested SRS characteristic; and
a configured SRS configuration.

Optionally, the sending module is further configured to:
send a third SRS configuration to the third access network device, where the third SRS configuration includes at least one of the following:
a TRP identifier;
a cell identifier; and
SRS configuration information.

Optionally, the apparatus further includes:
an ending module, configured to end the SDT when there is no data to be sent.

The first receiving module 601 is further configured to receive an RRC release message sent by the third access network device, where the RRC release message includes the first SRS configuration.

In this embodiment of this application, the apparatus can learn of coverage of another access network device that reserves an SRS resource for the terminal when the terminal is released to the RRC inactive state. Then, a serving base station can specify, before releasing the terminal to the RRC unconnected state, a specific access network device that reserves an SRS resource for the terminal. In this way, when the terminal is released to the RRC inactive state and moves into coverage of the access network device, the terminal can still send an uplink positioning reference signal based on the reserved SRS resource without re-obtaining an SRS configuration. This effectively reduces power consumption of the terminal in the inactive state.

The SRS configuration apparatus provided in this embodiment of this application can implement each process of the method embodiment in FIG. 2, and achieve the same technical effects. To avoid repetition, details are not described herein again.

FIG. 7 is a diagram 2 of a structure of an SRS configuration apparatus according to an embodiment of this application. The apparatus is used in an LMF. As shown in FIG. 7, the SRS configuration apparatus 700 includes:
a sending module 701, configured to send a first SRS configuration to a first access network device.

The first SRS configuration includes validity area information, and the validity area information is used for indicating coverage of a second access network device that reserves an SRS resource for a terminal when the terminal is released to an RRC inactive state.

Optionally, the sending module 701 is further configured to:
send a first request to the first access network device, where the first request includes indication information used for indicating whether the first SRS configuration is included.

Optionally, the first request includes at least one of the following:
first indication information, where the first indication information is used for indicating an RRC state requirement of LPHAP of the terminal; and
second indication information, where the second indication information is used for indicating whether the first SRS configuration is included.

Optionally, when the first request includes the first indication information, the first indication information indicates that the RRC state requirement of the LPHAP of the terminal is the RRC inactive state, and the first request includes an SRS configuration request, the first indication information is further used for indicating the indication information indicating whether the first SRS configuration is included.

Optionally, the apparatus further includes:
a receiving module, configured to receive a second SRS configuration sent by the first access network device, where the second SRS configuration includes at least one of the following:
third indication information, where the third indication information is used for indicating that an RRC state to which the terminal is to be released is the RRC inactive state or an RRC idle state; and
fourth indication information, where the fourth indication information is used for indicating to request the first SRS configuration.

Optionally, the sending module 701 is further configured to:
send a fourth request to the second access network device, where the fourth request is used for requesting to reserve the SRS resource.

The fourth request includes at least one of the following:
a TRP identifier;
a cell identifier;
a resource reservation identifier;
SRS configuration information; and
a request type.

Optionally, the receiving module is further configured to:
receive a second response sent by the second access network device, and determines the validity area information based on the second response, where the second response includes at least one of the following:
a response type;
system frame number SFN initialization time when the response type is agree; and
a reject reason when the response type is reject.

Optionally, if the terminal moves out of an area indicated by the validity area information and the first access network device is an access network device newly accessed by the terminal, the receiving module is further configured to:
receive first update information sent by the first access network device, where the first update information includes the second SRS configuration.

Optionally, the sending module 701 is further configured to:
send a resource reservation release message to a third access network device, where the third access network device is an original access network device of the terminal, and the resource reservation release message includes at least one of the following:
a TRP identifier;
a cell identifier;
a resource reservation identifier;
SRS configuration information; and
a message type.

In this embodiment of this application, the LMF determines the first SRS configuration, and sends the first SRS configuration to the first access network device currently accessed by the terminal, so that the first access network device can learn of coverage of another access network device that reserves an SRS resource for the terminal when the terminal is released to the RRC inactive state. Then, a serving base station can specify, before releasing the terminal to the RRC unconnected state, a specific access network device that reserves an SRS resource for the terminal. In this way, when the terminal is released to the RRC inactive state and moves into coverage of the access network device, the terminal can still send an uplink positioning reference signal based on the reserved SRS resource without re-obtaining an SRS configuration. This effectively reduces power consumption of the terminal in the inactive state.

The SRS configuration apparatus provided in this embodiment of this application can implement each process of the method embodiment in FIG. 3, and achieve the same technical effects. To avoid repetition, details are not described herein again.

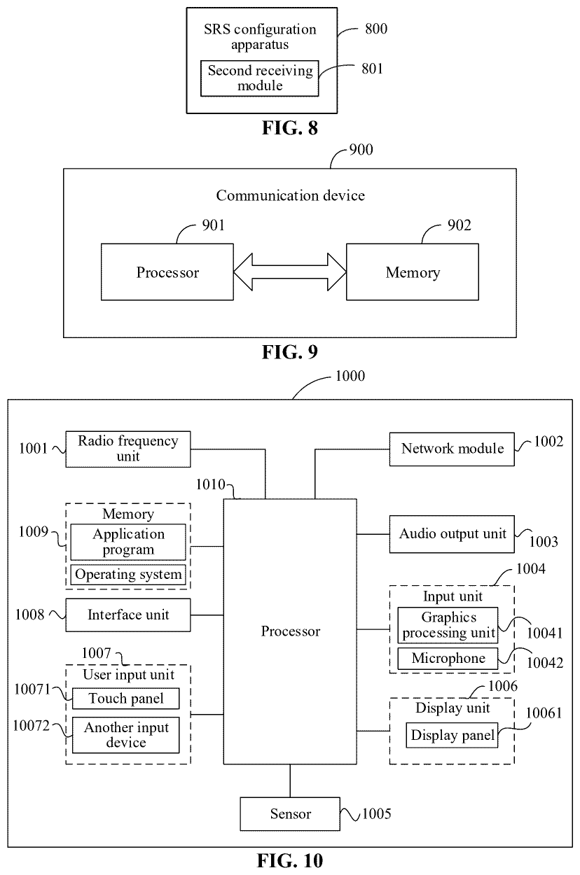

FIG. 8 is a diagram 3 of a structure of an SRS configuration apparatus according to an embodiment of this application. The apparatus is used in a terminal. As shown in FIG. 8, the SRS configuration apparatus 800 includes:
a second receiving module 801, configured to receive an RRC release message, where the RRC release message includes a first SRS configuration.

The first SRS configuration includes validity area information, and the validity area information is used for indicating coverage of a second access network device that reserves an SRS resource for the terminal when the terminal is released to an RRC inactive state.

Optionally, the apparatus further includes:
a sending module, configured to send a second request to a first access network device, where the second request is used for requesting to resume an RRC connection, and the first access network device is an access network device newly accessed by the terminal.

Optionally, the second request includes fifth indication information.

Alternatively, the sending module is further configured to perform the following operation.

The terminal sends a first message to the first access network device, where the first message includes fifth indication information.

Alternatively, the sending module is further configured to perform the following operation.

The terminal sends the second request and a first message to the first access network device, where the first message includes fifth indication information.

The fifth indication information is used for indicating that the terminal needs to update an SRS configuration.

In this embodiment of this application, the apparatus can learn, by using the RRC release message, of the coverage of the second access network device that reserves the SRS resource for the terminal when the terminal is released to the RRC inactive state, in other words, can learn of coverage of a specific access network device within which the terminal may still send the uplink positioning reference signal based on an SRS resource reserved by the access network device when the terminal is released to the RRC inactive state by the first access network device, without re-obtaining an SRS configuration, to reduce power consumption of the terminal in the inactive state.

The SRS configuration apparatus in this embodiment of this application may be an electronic device, for example, an electronic device having an operating system, or a component in the electronic device, for example, an integrated circuit or a chip. The electronic device may be a terminal, or may be another device other than the terminal. For example, the terminal may include, but is not limited to, the types of the terminal 11 listed above, and the another device may be a server, a network attached storage (NAS), or the like. This is not specifically limited in this embodiment of this application.

The SRS configuration apparatus provided in this embodiment of this application can implement each process of the method embodiment in FIG. 4, and achieve the same technical effects. To avoid repetition, details are not described herein again.

As shown in FIG. 9, an embodiment of this application further provides a communication device 900, including a processor 901 and a memory 902, where the memory 902 stores a program or instructions runnable on the processor 901. For example, when the communication device 900 is a terminal, and when the program or the instructions are executed by the processor 901, each step of the embodiment of the SRS configuration method shown in FIG. 4 is implemented, and the same technical effects can be achieved. When the communication device 900 is a first access network device, and when the program or the instructions are executed by the processor 901, each step of the embodiment of the SRS configuration method shown in FIG. 2 is implemented, and the same technical effects can be achieved. When the communication device 900 is an LMF, and when the program or the instructions are executed by the processor 901, each step of the embodiment of the SRS configuration method shown in FIG. 3 is implemented, and the same technical effects can be achieved. To avoid repetition, details are not described herein again.

An embodiment of this application further provides a terminal, including a processor and a communication interface. The communication interface is coupled to the processor, and the processor is configured to run a program or instructions, to implement a step in the method embodiment shown in FIG. 4. The terminal embodiment corresponds to the foregoing terminal side method embodiment, the implementation processes and implementation modes of the foregoing method embodiment may be applied to the terminal embodiment, and the same technical effects can be achieved. Specifically, FIG. 10 is a diagram of a hardware structure of a terminal according to an embodiment of this application.

The terminal 1000 includes, but is not limited to, at least some components of a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art may understand that the terminal 1000 may further include a power supply (for example, a battery) that supplies power to each component. The power supply may be logically connected to the processor 1010 through a power supply management system, to implement functions such as charging and discharging management, and power consumption management through the power supply management system. The structure of the terminal shown in FIG. 10 constitutes no limitation on the terminal, and the terminal may include more or fewer components than those shown in the figure, or combine some components, or have different component arrangements. Details are not described herein.

It should be understood that, in embodiments of this application, the input unit 1004 may include a graphics processing unit (GPU) 10041 and a microphone 10042. The graphics processing unit 10041 performs processing on image data of a static picture or a video that is obtained by an image acquisition device (for example, a camera) in a video acquisition mode or an image acquisition mode. The display unit 1006 may include a display panel 10061. The display panel 10061 may be configured by using a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a functional key (for example, a volume control key or a switch key), a track ball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes, but is not limited to, an antenna, an amplifier, a transceiver, a coupler, a low noise amplifier, a duplexer, and the like.

The memory 1009 may be configured to store a software program or instructions and various data. The memory 1009 may mainly include a first storage region storing the program or the instructions and a second storage region storing the data. The first storage region may store an operating system, an application program or instructions needed by at least one function (for example, a sound playback function and an image display function), and the like. In addition, the memory 1009 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), or a direct rambus random access memory (DR RAM). The memory 1009 in this embodiment of this application includes but is not limited to these memories and any other memory of a suitable type.

The processor 1010 may include one or more processing units. Optionally, the processor 1010 integrates an application processor and a modem processor. The application processor mainly processes operations related to an operating system, a user interface, an application, and the like. The modem processor mainly processes wireless communication signals, and is, for example, a baseband processor. It may be understood that the foregoing modem processor may not be integrated into the processor 1010.

The radio frequency unit 1001 is configured to receive an RRC release message, where the RRC release message includes a first SRS configuration.

The first SRS configuration includes validity area information, and the validity area information is used for indicating coverage of a second access network device that reserves an SRS resource for the terminal when the terminal is released to an RRC inactive state.

Optionally, the radio frequency unit 1001 is further configured to:
send a second request to a first access network device, where the second request is used for requesting to resume an RRC connection, and the first access network device is an access network device newly accessed by the terminal.

Optionally, the second request includes fifth indication information.

Alternatively, the radio frequency unit 1001 is further configured to:
send a first message to the first access network device, where the first message includes fifth indication information.

Alternatively, the radio frequency unit 1001 is further configured to:
send the second request and a first message to the first access network device, where the first message includes fifth indication information.

The fifth indication information is used for indicating that the terminal needs to update the SRS configuration.

In this embodiment of this application, the terminal can learn, by using the RRC release message, of the coverage of the second access network device that reserves the SRS resource for the terminal when the terminal is released to the RRC inactive state, in other words, can learn of coverage of a specific access network device within which the terminal may still send an uplink positioning reference signal based on an SRS resource reserved by the access network device when the terminal is released to the RRC inactive state by the first access network device, without re-obtaining an SRS configuration, to reduce power consumption of the terminal.

It may be understood that, for implementation processes of implementations in this embodiment, refer to related descriptions of the embodiment of the SRS configuration method. The same or corresponding technical effect is achieved. To avoid repetition, details are not described herein again.

An embodiment of this application further provides a network side device, including a processor and a communication interface. The communication interface is coupled to the processor, and the processor is configured to run a program or instructions, to implement a step in the method embodiment shown in FIG. 2. The embodiment of the network side device corresponds to the foregoing method embodiment of the access network device, the implementation processes and implementation modes of the foregoing method embodiment are all applicable to the embodiment of the network side device, and the same technical effect can be achieved.

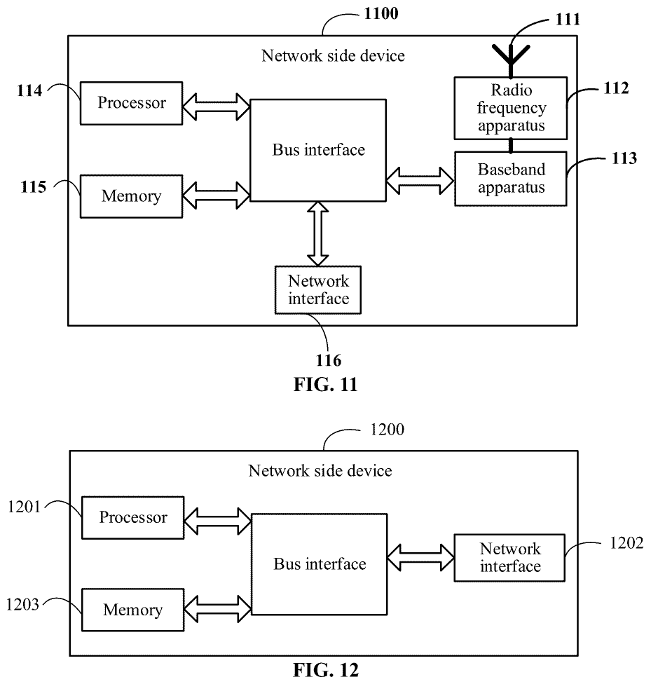

Specifically, an embodiment of this application further provides a network side device. As shown in FIG. 11, the network side device 1100 includes: an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends the processed information to the radio frequency apparatus 112. The radio frequency apparatus 112 processes the received information, and then sends the processed information through the antenna 111.

The method performed by the network side device in the foregoing embodiment may be implemented by the baseband apparatus 113. The baseband apparatus 113 includes a baseband processor.

The baseband apparatus 113 may include, for example, at least one baseband board. A plurality of chips are disposed on the baseband board. As shown in FIG. 11, one of the chips is, for example, the baseband processor, and is connected to the memory 115 through a bus interface to invoke a program in the memory 115, to perform an operation of a network device shown in the foregoing method embodiment.

The network side device may further include a network interface 116. The interface is, for example, a common public radio interface (CPRI).

Specifically, the network side device 1100 in this embodiment of the present invention further includes: instructions or a program stored in the memory 115 and runnable on the processor 114. The processor 114 invokes the instructions or the program in the memory 115 to perform the method performed by each module shown in FIG. 6, and achieves the same technical effects. To avoid repetition, details are not described herein again.

Specifically, an embodiment of this application further provides a network side device. As shown in FIG. 12, the network side device 1200 includes a processor 1201, a network interface 1202, and a memory 1203. The network interface 1202 is, for example, a common public radio interface (CPRI).

Specifically, the network side device 1200 in this embodiment of the present invention further includes: instructions or a program stored in the memory 1203 and runnable on the processor 1201. The processor 1201 invokes the instructions or the program in the memory 1203 to perform the method performed by each module shown in FIG. 7, and achieves the same technical effects. To avoid repetition, details are not described herein again.

An embodiment of this application further provides a readable storage medium. The readable storage medium stores a program or instructions. When the program or the instructions are executed by a processor, each process in the embodiment of the SRS configuration method in FIG. 2, FIG. 3, or FIG. 4 is implemented, and the same technical effects can be achieved. To avoid repetition, details are not described herein again.

The processor is a processor in the terminal described in the foregoing embodiment. The readable storage medium includes a computer-readable storage medium, for example, a computer read-only memory ROM, a random access memory RAM, a magnetic disk, or an optical disk. In some examples, the readable storage medium may be a non-transient readable storage medium.

An embodiment of this application further provides a chip. The chip includes a processor and a communication interface. The communication interface is coupled to the processor. The processor is configured to run a program or instructions, to implement each process of the embodiment of the SRS configuration method in FIG. 2, FIG. 3, or FIG. 4, and the same technical effects can be achieved. To avoid repetition, details are not described herein again.

It should be understood that the chip mentioned in this embodiment of this application may also be referred to as a system level chip, a system chip, a chip system, a system on a chip, or the like.

An embodiment of this application further provides a computer program/program product. The computer program/program product is stored in a storage medium. When the computer program/program product is executed by at least one processor, each process of the embodiment of the SRS configuration method in FIG. 2, FIG. 3, or FIG. 4 is implemented, and the same technical effects can be achieved. To avoid repetition, details are not described herein again.

An embodiment of this application further provides a communication system, including a terminal, an access network device, and an LMF. The terminal may be configured to perform a step of the method in FIG. 4, the access network device may be configured to perform a step of the method in FIG. 2, and the LMF may be configured to perform a step of the method in FIG. 3.

It should be noted that in this specification, the term “include”, “comprise”, or any other variants thereof are intended to encompass in a non-exclusive mode, so that a process, a method, an object, or an apparatus including a series of elements not only includes those elements, but also includes other elements that are not explicitly listed, or elements that are inherent to such a process, a method, an object, or an apparatus. Without more limitations, an element defined by a sentence “including one . . . ” does not exclude existence of other same elements in the process, the method, the object, or the apparatus that includes the element. In addition, it should be noted that a scope of the method and the apparatus in the implementations of this application is not limited to performing functions according to a sequence that is shown or discussed, but may further include performing functions in a substantially simultaneous manner or in a reversed sequence based on the related functions. For example, the described method may be performed in a different order than a described order, and various steps may be added, omitted, or combined. In addition, features described with reference to some examples may be combined in other examples.

Through the descriptions of the foregoing implementations, a person skilled in the art may clearly understand that the method according to the foregoing embodiment may be implemented by using a computer software product and a necessary general hardware platform, and certainly, may alternatively be implemented by hardware. The computer software product is stored in a storage medium (for example, a ROM, a RAM, a magnetic disk, or an optical disc) and includes several instructions for instructing a terminal or a network side device to perform the method described in embodiments of this application.

Embodiments of this application are described above with reference to the accompanying drawings. However, this application is not limited to the specific implementations described above, and the specific implementations are merely examples and constitute no limitations.

What is claimed is:

1. A sounding reference signal (SRS) configuration method, comprising:
receiving, by a first access network device, a first SRS configuration sent by a location management function (LMF), wherein
the first SRS configuration comprises validity area information, and the validity area information is used for indicating coverage of a second access network device that reserves an SRS resource for a terminal when the terminal is released to a radio resource control (RRC) inactive state.

2. The method according to claim 1, wherein the method further comprises:
sending, by the first access network device, an RRC release message to the terminal, wherein the RRC release message comprises the first SRS configuration.

3. The method according to claim 1, wherein before the receiving, by the first access network device, the first SRS configuration sent by the LMF, the method further comprises:
receiving, by the first access network device, a first request sent by the LMF, wherein the first request comprises indication information used for indicating whether the first SRS configuration is comprised.

4. The method according to claim 3, wherein the first request comprises at least one of the following:
first indication information, wherein the first indication information is used for indicating an RRC state requirement of low-power high-accuracy positioning (LPHAP) of the terminal; or
second indication information, wherein the second indication information is used for indicating whether the first SRS configuration is comprised;
wherein when the first request comprises the first indication information, the first indication information indicates that the RRC state requirement of the LPHAP of the terminal is the RRC inactive state, and the first request comprises an SRS configuration request, the first indication information is further used for indicating the indication information indicating whether the first SRS configuration is comprised.

5. The method according to claim 3, wherein after the receiving, by the first access network device, the first request sent by the LMF, the method further comprises:
determining, by the first access network device, a second SRS configuration based on the first request, and sending the second SRS configuration to the LMF, wherein the second SRS configuration comprises at least one of the following:
third indication information, wherein the third indication information is used for indicating that an RRC state to which the terminal is to be released is the RRC inactive state or an RRC idle state; or
fourth indication information, wherein the fourth indication information is used for indicating to request the first SRS configuration.

6. The method according to claim 1, wherein when the terminal moves out of an area indicated by the validity area information and the first access network device is an access network device newly accessed by the terminal, before the receiving, by the first access network device, the first SRS configuration sent by the LMF, the method further comprises:
receiving, by the first access network device, a second request sent by the terminal, wherein the second request is used for requesting to resume an RRC connection;
wherein the second request comprises fifth indication information;
the fifth indication information is used for indicating that the terminal needs to update an SRS configuration.

7. The method according to claim 6, wherein after the sending, by the first access network device, the third request to the third access network device, the method further comprises:
receiving, by the first access network device, a first response sent by the third access network device, wherein the first response comprises at least one of the following:
sixth indication information, wherein the sixth indication information is used for indicating the RRC state requirement of the LPHAP of the terminal; or
seventh indication information, wherein the seventh indication information is used for indicating whether the first SRS configuration is comprised;
wherein after the receiving, by the first access network device, the first response sent by the third access network device, and before the receiving, by the first access network device, the first SRS configuration sent by the LMF, the method further comprises:
sending, by the first access network device, first update information to the LMF, wherein the first update information comprises at least one of the following:
eighth indication information, wherein the eighth indication information is used for indicating that the RRC state to which the terminal is to be released is the RRC inactive state or the RRC idle state; or
ninth indication information, wherein the ninth indication information is used for indicating to request the first SRS configuration.

8. The method according to claim 6, wherein after the sending, by the first access network device, the third request to the third access network device, the method further comprises:
receiving, by the first access network device, a part of terminal context sent by the third access network device.

9. The method according to claim 8, wherein the part of terminal context comprises at least one of the following:
a requested SRS characteristic; or
a configured SRS configuration;
or,
wherein after the receiving, by the first access network device, the part of terminal context sent by the third access network device, the method further comprises:
sending, by the first access network device, a third SRS configuration to the third access network device, wherein the third SRS configuration comprises at least one of the following:
a TRP identifier;
a cell identifier; or
SRS configuration information;
or,
wherein after the sending, by the first access network device, the third SRS configuration to the third access network device, the method further comprises:
ending, by the first access network device when there is no data to be sent, small data transmission SDT; and
receiving, by the first access network device, an RRC release message sent by the third access network device, wherein the RRC release message comprises the first SRS configuration.

10. An SRS configuration method, comprising:
sending, by an LMF, a first SRS configuration to a first access network device, wherein
the first SRS configuration comprises validity area information, and the validity area information is used for indicating coverage of a second access network device that reserves an SRS resource for a terminal when the terminal is released to an RRC inactive state.

11. The method according to claim 10, wherein before the sending, by the LMF, the first SRS configuration to the first access network device, the method further comprises:
sending, by the LMF, a first request to the first access network device, wherein the first request comprises indication information used for indicating whether the first SRS configuration is comprised.

12. The method according to claim 11, wherein the first request comprises at least one of the following:
first indication information, wherein the first indication information is used for indicating an RRC state requirement of LPHAP of the terminal; or
second indication information, wherein the second indication information is used for indicating whether the first SRS configuration is comprised;
wherein when the first request comprises the first indication information, the first indication information indicates that the RRC state requirement of the LPHAP of the terminal is the RRC inactive state, and the first request comprises an SRS configuration request, the first indication information is further used for indicating the indication information indicating whether the first SRS configuration is comprised.

13. The method according to claim 11, wherein after the sending, by the LMF, the first request to the first access network device, the method further comprises:
receiving, by the LMF, a second SRS configuration sent by the first access network device, wherein the second SRS configuration comprises at least one of the following:
third indication information, wherein the third indication information is used for indicating that an RRC state to which the terminal is to be released is the RRC inactive state or an RRC idle state; or
fourth indication information, wherein the fourth indication information is used for indicating to request the first SRS configuration.

14. The method according to claim 13, wherein after the receiving, by the LMF, the second SRS configuration sent by the first access network device, the method further comprises:
sending, by the LMF, a fourth request to the second access network device, wherein the fourth request is used for requesting to reserve the SRS resource, wherein
the fourth request comprises at least one of the following:
a TRP identifier;
a cell identifier;
a resource reservation identifier;
SRS configuration information; or
a request type;
wherein after the sending, by the LMF, the fourth request to the second access network device, the method further comprises:
receiving, by the LMF, a second response sent by the second access network device, and determining the validity area information based on the second response, wherein the second response comprises at least one of the following:
a response type;
system frame number SFN initialization time when the response type is agree; or
a reject reason when the response type is reject.

15. The method according to claim 13, wherein when the terminal moves out of an area indicated by the validity area information and the first access network device is an access network device newly accessed by the terminal, the receiving, by the LMF, the second SRS configuration sent by the first access network device comprises:
receiving, by the LMF, first update information sent by the first access network device, wherein the first update information comprises the second SRS configuration;
wherein after the sending, by the LMF, the first SRS configuration to the first access network device, the method further comprises:
sending, by the LMF, a resource reservation release message to a third access network device, wherein the third access network device is an original access network device of the terminal, and the resource reservation release message comprises at least one of the following:
a TRP identifier;
a cell identifier;
a resource reservation identifier;
SRS configuration information; or
a message type.

16. An SRS configuration method, comprising:
receiving, by a terminal, an RRC release message, wherein the RRC release message comprises a first SRS configuration, wherein
the first SRS configuration comprises validity area information, and the validity area information is used for indicating coverage of a second access network device that reserves an SRS resource for the terminal when the terminal is released to an RRC inactive state.

17. The method according to claim 16, wherein when the terminal moves out of an area indicated by the validity area information, the method further comprises:
sending, by the terminal, a second request to a first access network device, wherein the second request is used for requesting to resume an RRC connection, and the first access network device is an access network device newly accessed by the terminal;
wherein the second request comprises fifth indication information;
the fifth indication information is used for indicating that the terminal needs to update an SRS configuration.

18. A terminal, comprising a processor and a memory, wherein the memory stores a program or instructions runnable on the processor, and when the program or the instructions are executed by the processor, a step of the SRS configuration method according to claim 16 is implemented.

19. A network side device, comprising a processor and a memory, wherein the memory stores a program or instructions runnable on the processor, and when the program or the instructions are executed by the processor, a step of the SRS configuration method according to claim 1 is implemented.

20. A network side device, comprising a processor and a memory, wherein the memory stores a program or instructions runnable on the processor, and when the program or the instructions are executed by the processor, a step of the SRS configuration method according to claim 10 is implemented.
